(19) United States
(12) Patent Application Publication
(10) Pub. No.: US 2011/0051868 A1
(43) Pub. Date: Mar. 3, 2011

(54) VARIOUS IMPEDANCE FM RECEIVER

(75) Inventors: Razieh Roufoogaran, Venice, CA (US); Bojko F. Marholev, Bjarred (SE)

(73) Assignee: BROADCOM CORPORATION, Irvine, CA (US)

(21) Appl. No.: 12/552,047

(22) Filed: Sep. 1, 2009

(51) Int. Cl. H04B 1/06; H04B 1/10

(52) U.S. Cl. 375/350; 455/269

(57) ABSTRACT

A receiver within a wireless device is able to couple to different antennas with different impedances. The wireless device includes a first antenna pin for coupling to a first antenna with a first impedance, a second antenna pin for coupling to a second antenna with a second impedance and a switch for selecting at least one of the first antenna and the second antenna to couple to the receiver.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention is related generally to frequency modulated (FM) systems, and more particularly to FM receiver architectures.

2. Description of Related Art

Conventional broadcast radio stations operate on fixed radio frequency (RF) channels. In the U.S., these channels are regulated and licensed for specific purposes by the Federal Communications Commission (FCC). For example, the frequency band from 535 kilohertz (kHz) to 1.7 megahertz (MHz) is designated for AM broadcast radio, while the frequency band from 88 MHz to 108 MHz is designated for FM broadcast radio. Within any particular region of the U.S., there may be one or more radio stations broadcasting within the FM frequency band. The FCC designates a particular FM radio channel to each radio station, so that no two radio stations are broadcasting on the same radio channel within the same region.

To tune a radio device to a particular broadcasting radio station, either a user can select the desired radio channel on the radio device or the radio device can scan through the FM frequency band until the desired radio channel is reached. Increasingly, FM radio devices are being incorporated into hand-held wireless devices, such as cell phones, personal audio/visual (A/V) players, personal digital assistants (PDAs) and other similar devices, to enable users to listen to broadcast radio on their wireless device.

In addition, outside of the broadcast spectrum, FM radio devices are being used within two-way radio devices to search for FM channels with a valid transmission. To avoid interference with nearby FM radio stations, the radio devices communicate on FM radio channels that are inactive in the region that the radio devices are located. That is, the radio devices communicate using FM radio channels that are not allocated to any radio station within the area and on which no signal is currently present.

Once communication between the radio devices is established over an inactive FM radio channel, the radio devices may communicate audio data (e.g., speech or music) and/or digital data, such as numeric messages and/or text messages, over the FM radio channel. In addition, the radio devices may employ modulation schemes, such as frequency shift keying, audio frequency shift keying or quadrature shift keying to encode the data. Therefore, each FM radio device typically includes a built-in transceiver (transmitter and receiver) for modulating/demodulating information (data or speech) bits into a format that comports with a particular communication standard utilized by the radio devices.

When the FM radio device is incorporated into another wireless device, such as a cell phone, the transceiver can be shared between FM and traditional cellular operations. Therefore, a traditional cell phone antenna, i.e., a 50 ohm antenna, typically provides both cellular and FM reception. However, using a 50 ohm antenna requires FM transceivers to be operated at high power. As a result, FM transceivers often suffer from a shortened battery life. Therefore, manufacturers and users of FM transceivers may want to utilize different types of antennas in the transmit and/or receive paths.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram illustrating a communication system that includes FM radio devices capable of communicating with each other using frequencies within the FM radio spectrum in accordance with the present invention;

FIG. 2 is a schematic block diagram illustrating a wireless device that includes a host device and an associated FM radio in accordance with the present invention;

FIG. 3 is a schematic block diagram illustrating an FM radio receiver in accordance with the present invention;

FIG. 4 is a schematic block diagram illustrating the FM radio receiver including variable gain stages in accordance with the present invention;

FIGS. 5-7 are schematic block diagrams illustrating more detailed views of a wireless device including an FM radio receiver in accordance with the present invention;

FIG. 8 is a circuit diagram illustrating an exemplary low noise amplifier for use within the FM radio receiver in accordance with the present invention;

FIG. 9 is a logic diagram of a method for operating a wireless device including an FM radio receiver in accordance with the present invention; and

FIG. 10 is a logic diagram of a method for configuring an FM radio receiver, in accordance with the present invention.

### DETAILED DESCRIPTION OF THE INVENTION

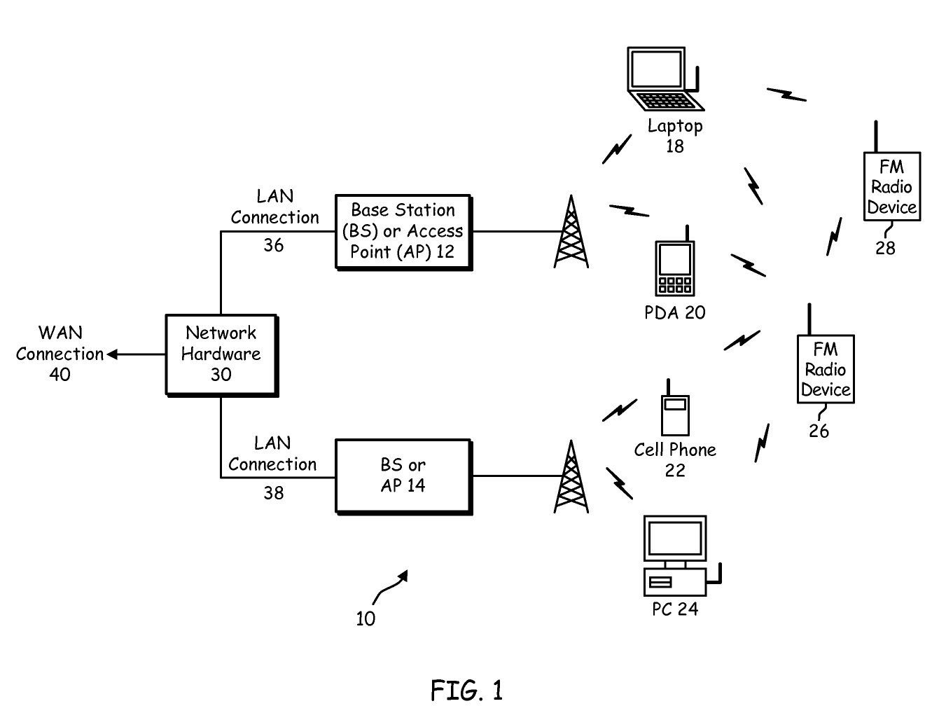

FIG. 1 is a functional block diagram illustrating an exemplary wireless system 10 for use in embodiments of the present invention. The wireless system shown in FIG. 1 includes a plurality of wireless devices 18-28. For example, the wireless devices may be radio devices, such as FM radio devices 26 and 28, or communication devices, such as laptop computer 18, personal digital assistant 20, cellular telephone 22 and/or personal computer 24. FM radio devices 26 and 28 may be car radios, portable radios, personal A/V players, such as MP3 players, and/or other wireless devices that include FM radio devices.

Currently, there is a trend towards enabling cellular telephone 22 and other wireless devices, such as laptop computers 18, PDAs 20, personal computers 24 and other devices 26 and 28 (e.g., MP3 players, portable radios, etc.), to provide FM transmission and/or reception. Therefore, in FIG. 1, each of the wireless devices 18-28 may include an FM transmitter operable to transmit a frequency modulated (FM) signal within the FM frequency band on one or more FM radio frequencies. In addition, each of the wireless devices 18-28 may further include an FM receiver operable to receive an FM signal within the FM frequency band on one or more FM radio frequencies. As used herein, the term “FM frequency band” includes frequencies between 65 MegaHertz (MHz) and 108 MHz.

For example, in the U.S., FM radio stations are allocated respective FM channels, each containing 200 kHz of bandwidth around the carrier frequency (in Europe, it is 100 kHz). To listen to broadcast radio on the wireless devices, each of the wireless devices 18-28 includes an FM receiver operable to tune to a particular FM channel and receive a radio frequency (RF) signal within the FM frequency band on the selected FM radio channel.

In addition, to enable two-way radio communication over FM channels, each of the wireless devices 18-28 further includes an FM transmitter. To avoid interference with nearby FM radio stations, the wireless devices 18-28 communicate on FM radio channels that are inactive in the region that the wireless devices 18-28 are located. That is, the wireless devices 18-28 communicate using FM radio channels that are not allocated to any radio station within the area and on which no signal is currently present.

Once communication between the wireless devices is established over an inactive FM radio channel, the wireless devices may communicate audio data (e.g., speech and/or music) and/or digital data, such as numeric messages and/or text messages, over the FM radio channel. In addition, the wireless devices 18-28 may employ modulation schemes, such as frequency shift keying, audio frequency shift keying or quadrature shift keying to encode the data transmitted via the selected inactive FM channel. For example, if a received FM radio signal includes digital data, the wireless device 18-28 receiving the FM radio signal can demodulate the digital data, and then display the digital data on a display of the wireless device 18-28.

Furthermore, each of the communication devices 18-24 includes a transceiver (transmitter and receiver) for communicating with a base station or access point 12-14 of a wireless communication network. In one embodiment, the communication devices 18-24 include separate transceivers for FM and cellular communications. In another embodiment, the communication devices 18-24 include a single transceiver capable of supporting both FM and cellular operations.

Typically, base stations are used for cellular telephone networks and like-type networks, while access points are used for in-home or in-building wireless networks. For example, access points are typically used in Bluetooth systems. Regardless of the particular type of wireless communication network, the communication devices 18-24 and the base station or access point 12-14 each include a built-in transceiver (transmitter and receiver) for modulating/demodulating information (data or speech) bits into a format that comports with the type of wireless communication network. There are a number of well-defined wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof) that could facilitate such wireless communication between the communication devices 18-24 and a wireless communication network.

The base stations or access points 12-14 are coupled to a network hardware component 30 via local area network (LAN) connections 36 and 38. The network hardware component 34, which may be a router, switch, bridge, modem, system controller, etc., provides a wide area network (WAN) connection 40 for the wireless communication network. Each of the base stations or access points 12-14 has an associated antenna or antenna array to communicate with the wireless communication devices in its area. Typically, the wireless communication devices 18-24 register with the particular base station or access points 12 or 14 to receive services from the wireless network. For direct connections (i.e., point-to-point communications), wireless communication devices communicate directly via an allocated channel. Although a network topology is shown in FIG. 1, it should be understood that the present invention is not limited to network topologies, and may be used in other environments, such as peer-to-peer, access point or mesh environments.

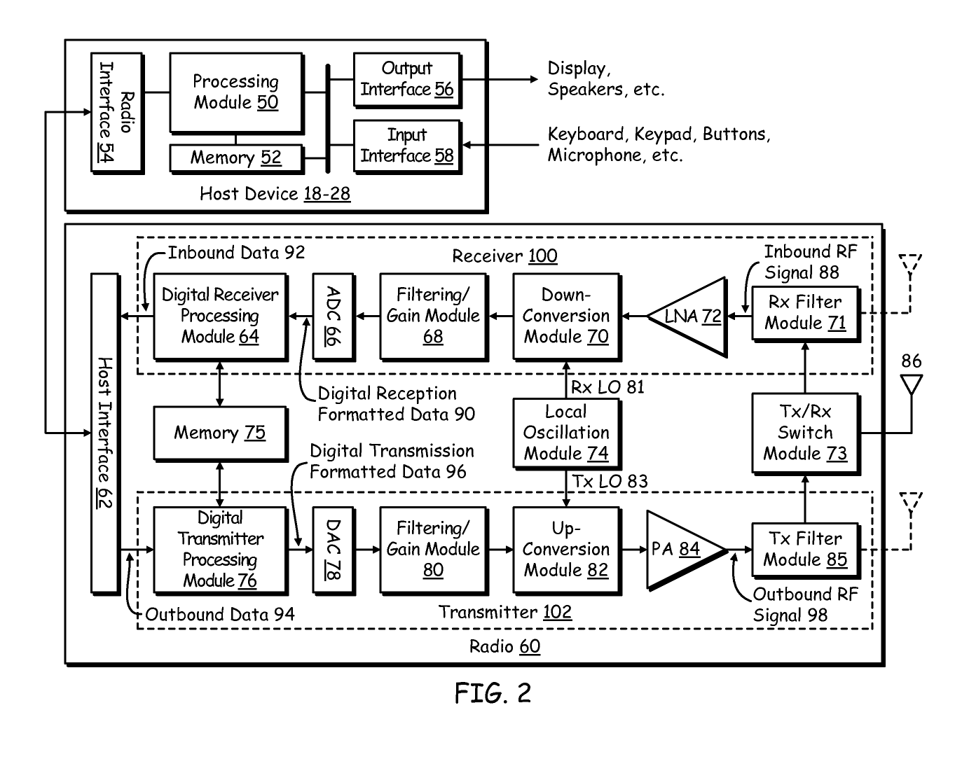

FIG. 2 is a schematic block diagram illustrating a wireless device that includes the host device 18-28 and an associated radio 60, which can be an FM radio, a cellular radio or a combined FM/cellular radio. For cellular telephone hosts and radio hosts, the radio 60 is a built-in component. For personal digital assistants hosts, laptop hosts, and/or personal computer hosts, the radio 60 may be built-in or an externally coupled component.

As illustrated, the host device 18-28 includes a processing module 50, memory 52, a radio interface 54, an input interface 58 and an output interface 56. The processing module 50 and memory 52 execute the corresponding instructions that are typically done by the host device 18-28. For example, for a cellular telephone host device, the processing module 50 performs the corresponding communication functions in accordance with a particular cellular telephone standard.

The radio interface 54 allows data to be received from and/or sent to the radio 60. For data received from the radio 60 (e.g., inbound data), the radio interface 54 provides the data to the processing module 50 for further processing and/or routing to the output interface 56. The output interface 56 provides connectivity to an output device such as a display, monitor, speakers, etc., such that the received data may be displayed. The radio interface 54 also provides data from the processing module 50 to the radio 60. The processing module 50 may receive the outbound data from an input device, such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a transmitter 102, a memory 75, a local oscillation module 74, and in embodiments in which the radio 60 is a transceiver, a receiver 100 and an optional transmitter/receiver (Tx/Rx) switch module 73. The radio 60 further includes an antenna 86. In the transceiver shown in FIG. 2, the antenna 86 is shared by the transmit and receive paths as regulated by the Tx/Rx switch module 73. However, in other embodiments, the transmit and receive paths may use separate antennas or multiple antennas can be coupled to the Tx/Rx switch module 73 to switch between different antennas for the transmit and receive paths. In addition, in embodiments in which the host device 18-28 is a communication device, such as a cell phone, laptop computer, personal computer or PDA, the radio 60 and antenna 86 may be shared between cellular and FM applications. For example, the local oscillation module 74 may be configured to provide an appropriate local oscillation signal for up-converting and down-converting both FM and cellular frequencies, depending on the mode of operation (FM or cellular). In other embodiments, a separate antenna 86 and/or radio 60 may be provided for cellular and FM applications.

As shown in FIG. 2, the receiver 100 includes a digital receiver processing module 64, an analog-to-digital converter 66, a filtering/gain module 68, a down-conversion module 70, a low noise amplifier 72 and a receiver filter module 71. The transmitter 102 includes a digital transmitter processing module 76, a digital-to-analog converter 78, a filtering/gain module 80, an IF mixing up-conversion module 82, a power amplifier 84 and a transmitter filter module 85.

The digital receiver processing module 64 and the digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and/or modulation. The digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the digital receiver processing module 64 and/or the digital transmitter processing module 76 implements one or more of its functions via analog circuitry, digital circuitry, and/or logic circuitry, the memory storing the corresponding operational instructions is embedded with the circuitry comprising the analog circuitry, digital circuitry, and/or logic circuitry. Memory 75 stores, and the digital receiver processing module 64 and/or the digital transmitter processing module 76 executes, operational instructions corresponding to at least some of the functions illustrated herein.

In an exemplary operation of the receiver 100, when the radio 60 receives an inbound radio frequency (RF) signal 88 having a particular bandwidth and carrier frequency tuned to by the antenna 86, which was transmitted by another wireless device, the antenna 86 provides the inbound RF signal 88 to the receiver filter module 71 via the Tx/Rx switch module 73. The Rx filter module 71 bandpass filters the inbound RF signal 88 and provides the filtered RF signal to low noise amplifier 72, which amplifies the inbound RF signal 88 to produce an amplified inbound RF signal. The low noise amplifier 72 provides the amplified inbound RF signal to the down-conversion module 70, which directly converts the amplified inbound RF signal into an inbound low IF signal (e.g., at 200 kHz IF) based on a receiver local oscillation 81 provided by local oscillation module 74. The down-conversion module 70 provides the inbound low IF signal to the filtering/gain module 68.

The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92. The host interface 62 provides the recaptured inbound data 92 to the host device 18-32 via the radio interface 54.

In an exemplary operation of the transmitter 102, when the radio 60 receives outbound data 94 from the host device 18-28 via the host interface 62, the host interface 62 routes the outbound data 94 to the digital transmitter processing module 76. The digital transmitter processing module 76 processes the outbound data 94 in accordance with a particular wireless communication standard (e.g., IEEE 802.11a, IEEE 802.11b, Bluetooth, etc.), if necessary, to produce digital transmission formatted data 96. The digital-to-analog converter 78 converts the digital transmission formatted data 96 from the digital domain to the analog domain. The filtering/gain module 80 filters and/or adjusts the gain of the analog low IF signal prior to providing it to the up-conversion module 82. The up-conversion module 82 directly converts the analog low IF signal into an RF signal based on a transmitter local oscillation 83 provided by local oscillation module 74. The power amplifier 84 amplifies the RF signal to produce an outbound RF signal 98, which is filtered by the transmitter filter module 85. The antenna 86 transmits the outbound RF signal 98 to a targeted device, such as another wireless device.

As one of average skill in the art will appreciate, the wireless device of FIG. 2 may be implemented using one or more integrated circuits. For example, the host device 18-28 may be implemented on a first integrated circuit, while the digital receiver processing module 64, memory 75 and/or the digital transmitter processing module 76 may be implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device 18-28 and the digital receiver processing module 64 and/or the digital transmitter processing module 76 may be a common processing device implemented on a single integrated circuit. Further, memory 52 and memory 75 may be implemented on a single integrated circuit and/or on the same integrated circuit as the common processing modules of processing module 50, the digital receiver processing module 64, and/or the digital transmitter processing module 76.

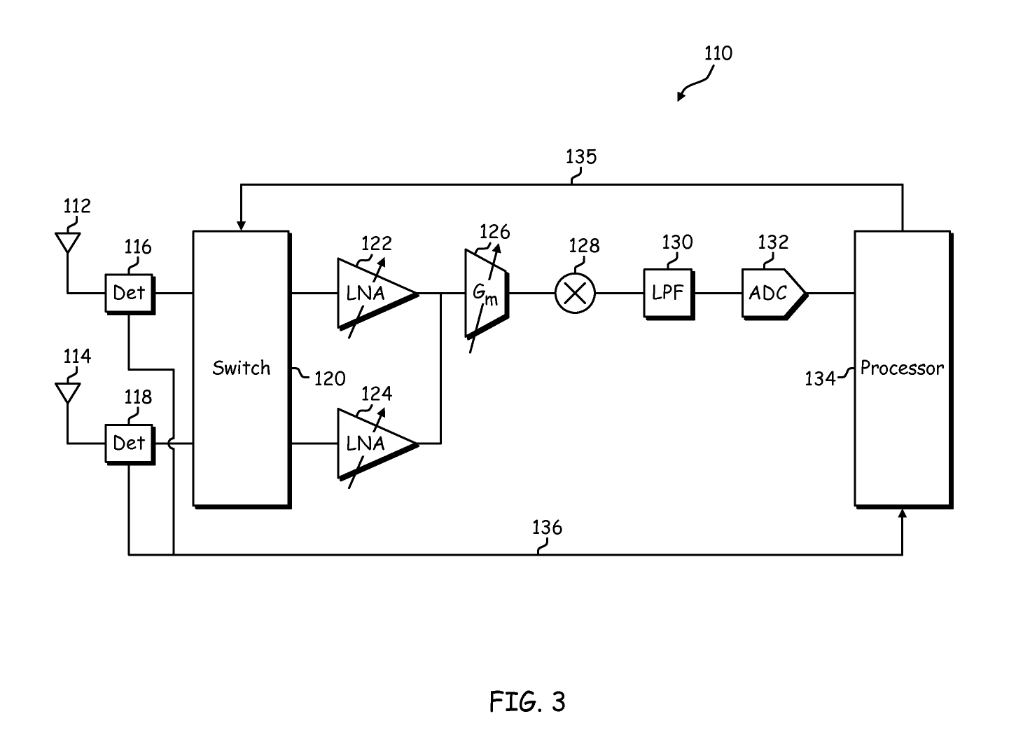

FIG. 3 is a schematic block diagram illustrating an FM radio receiver 110 in accordance with the present invention. The FM radio receiver 110 corresponds, at least in part, to the receiver 100 shown in FIG. 2. The FM radio receiver 110 of FIG. 3 provides a flexible architecture to enable different types of antennas with different impedances to be coupled to the FM receiver 110.

The FM radio receiver in FIG. 3 includes antennas 112 and 114, antenna pins 116/118, switch 120, low noise amplifiers 122 and 124, an optional gain stage (Gm) 126, a mixer 128, a low pass filter (LPF) 130, analog-to-digital converter (ADC) 132 and digital baseband processor 134, which correspond, at least in part, to the functionality of blocks 64-73 and 86 of FIG. 2. The processor 134 may be a microprocessor, micro-controller, digital signal processor, microcomputer, central processing unit, field programmable gate array, programmable logic device, logic circuitry, analog circuitry, digital circuitry, and/or any device that manipulates signals (analog and/or digital) based on operational instructions.

The antennas 112 and 114 can each be a different type of antenna and/or have different impedances. For example, antenna 112 can be a cell phone antenna with an impedance of 50 Ω (ohms), while antenna 114 can be a loop antenna with an impedance of 2 kΩ. As another example, one of the antennas could be a small form factor (SFF) antenna or any other type of antenna.

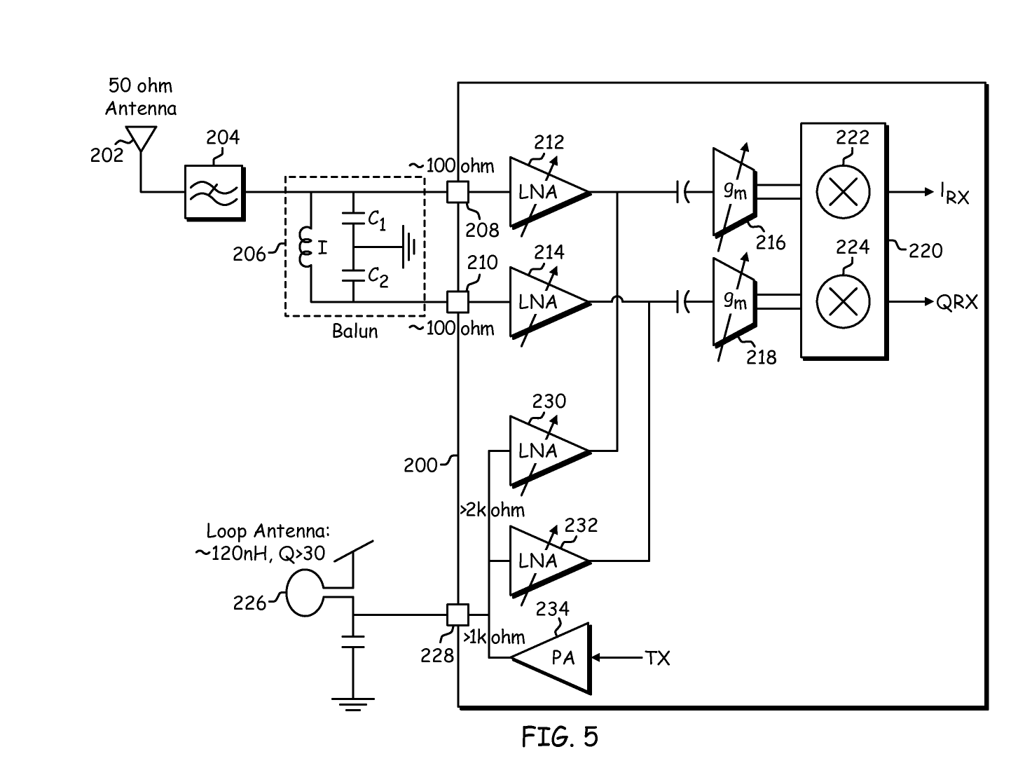

To enable different antennas with different impedances to be coupled to the receiver 110, each of the LNAs 122/124 has a programmable impedance, as described in more detail below in connection with FIGS. 5-8, in order to provide either antenna impedance matching or no matching (for low impedance antennas). The LNA 122/124 impedance can be set off-line during manufacture of the wireless device incorporating the FM receiver 110 and/or in real-time, for example, in response to a new antenna being coupled to the FM receiver 110 by a user.

Once the LNA impedances have been set based on the types of antennas 112/114 inserted into antenna pins 116/118, switch 120 selectively couples antenna 112 to LNA 122 and antenna 114 to LNA 124. For example, switch 120 can couple only antenna 112 to LNA 122, only antenna 114 to LNA 124 or both antenna 112 to LNA 122 and antenna 114 to LNA 124. In one embodiment, switch 120 operates to selectively physically couple antenna 112 to LNA 122 and to selectively physically couple antenna 114 to LNA 124. In another embodiment, switch 120 functions as a power control module to selectively provide power to LNA 122 and/or LNA 124, and therefore, effectively selectively couple LNAs 122/124 to antennas 112/114. In addition, although two LNA's 122 and 124 are shown, in other embodiments, only a single LNA (e.g., LNA 122) may be used and the switch 120 operates to couple one of the antennas 112/114 to the single LNA 122.

The switch 120 can further operate as the Tx/Rx switch module shown in FIG. 2 if only one of the antennas 112/114 is used for both transmit and receive operations. For example, antenna pin 116 can be an Rx (receiver) antenna pin, while antenna pin 118 can be a Tx (transmitter) antenna pin. Switch 120 can enable the receiver 110 to utilize the Tx antenna 114 while in a receive mode and the transmitter (not shown) to utilize the Tx antenna 114 while in a transmit mode. In addition, simultaneous transmit/receive operations may be possible. For example, when the transmitter is operating in a cellular mode via antenna 114, the receiver 110 may be able to simultaneously receive an FM signal via antenna 112 or antenna 114.

In an exemplary operation, switch 120 couples antenna 114 to LNA 124 to enable an inbound radio frequency (RF) signal received at antenna 114 to be provided to LNA 124. LNA 124 amplifies the inbound RF signal to produce an amplified inbound RF signal. The LNA 124 provides the amplified inbound RF signal to the mixer 128 via the optional gain stage 126. The mixer 128 converts the amplified inbound RF signal into an inbound low IF or near baseband signal (e.g., at 200 kHz IF). The mixer 128 provides the inbound near baseband signal to the LPF 130, which filters the near baseband signal to produce a filtered baseband signal. The ADC 132 converts the filtered baseband signal from the analog domain to the digital domain to produce a digital baseband signal and provides the digital baseband signal to the processor 134. The processor 134 decodes, descrambles, demaps, and/or demodulates the digital baseband signal to recapture inbound data (i.e., inbound digital symbols).

In another exemplary operation, switch 120 couples antenna 112 to LNA 122 to enable an inbound radio frequency (RF) signal received at antenna 112 to be provided to LNA 122. LNA 122 amplifies the inbound RF signal to produce an amplified inbound RF signal. The LNA 122 provides the amplified inbound RF signal to the mixer 128 via the optional gain stage 126. The mixer 128 converts the amplified inbound RF signal into an inbound low IF or near baseband signal (e.g., at 200 kHz IF). The mixer 128 provides the inbound near baseband signal to the LPF 130, which filters the near baseband signal to produce a filtered baseband signal. The ADC 132 converts the filtered baseband signal from the analog domain to the digital domain to produce a digital baseband signal and provides the digital baseband signal to the processor 134. The processor 134 processes the digital baseband signal to recapture inbound data (i.e., inbound digital symbols).

In yet another exemplary operation, switch 120 couples antenna 112 to LNA 122 and couples antenna 114 to LNA 124 to enable respective inbound radio frequency (RF) signals received at antennas 112 and 114 to be provided to LNAs 122 and 124. LNAs 122 and 124 each amplify the respective inbound RF signal to produce respective amplified inbound RF signals. The outputs of LNAs 122 and 124 are combined to produce a combined amplified inbound RF signal that is input to the mixer 128 via the optional gain stage 126. The mixer 128 converts the combined amplified inbound RF signal into an inbound low IF or near baseband signal (e.g., at 200 kHz IF). The mixer 128 provides the inbound near baseband signal to the LPF 130, which filters the near baseband signal to produce a filtered baseband signal. The ADC 132 converts the filtered baseband signal from the analog domain to the digital domain to produce a digital baseband signal and provides the digital baseband signal to the processor 134. The processor 134 processes the digital baseband signal to recapture inbound data (i.e., inbound digital symbols).

Each antenna pin 116 and 118 can also include an antenna detector circuit that transmits a signal to the digital baseband processor 134 whenever an antenna is inserted into the antenna pin 116/118. The processor 134 may control the selective coupling of one or both of the antennas 112/114 to the receiver based upon the detection signal. For example, in an exemplary operation, at least one of antenna detector circuits 116/118 detects the presence of an antenna 112/114 and transmits a signal 136 indicative of the antenna presence to the processor 134. In response, the processor 134 sends a signal 135 to the switch 120 to couple one or both antennas 112/114 to LNAs 122/124 based on pre-defined criteria.

In one embodiment, the pre-defined criteria can indicate that if an antenna 112 is coupled to the receiver pin 116, the receiver antenna 112 is coupled to the LNA 122, and any antenna 114 present on the transmitter pin 118 is not connected to LNA 124. In another embodiment, the pre-defined criteria can couple both antennas 112/114 to their respective LNAs 122/124 in order to boost the signal in the receiver 110.

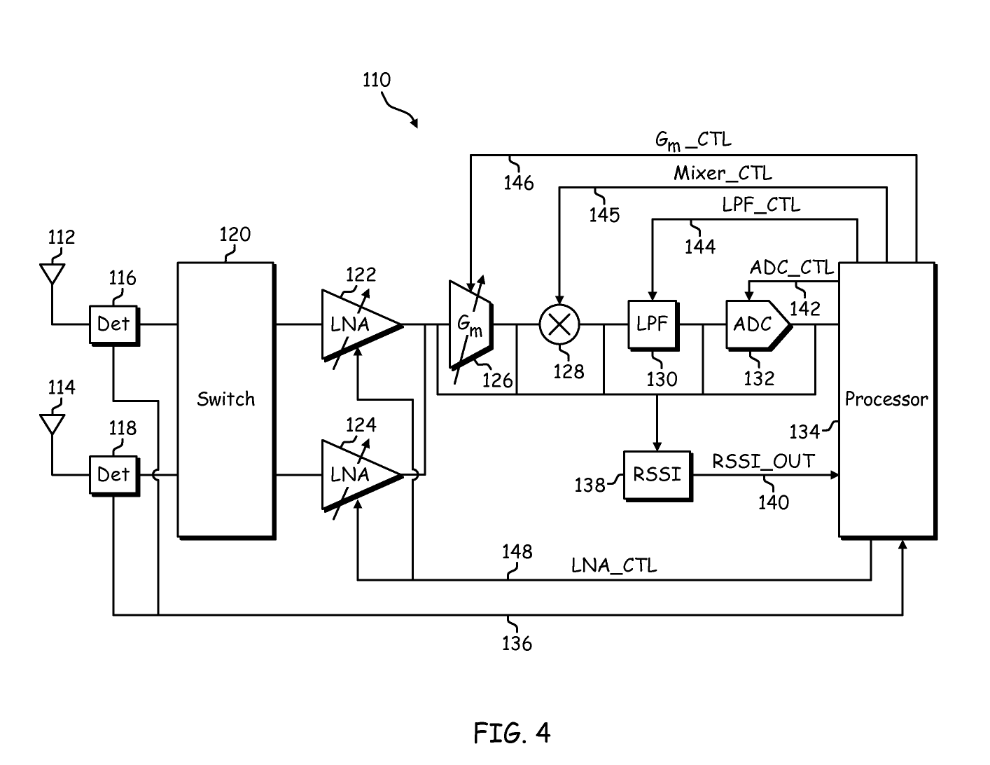

The antenna detector circuits may further be able to measure the impedance of the antennas to determine the type of antennas 116/118 inserted into the pins 116/118 to enable automatic configuration of the LNA impedance to match the antenna impedance. For example, the processor 134 can transmit a signal to the LNA's 122/124 to set the respective impedances thereof based on the measured impedance of the antennas 112/114 inserted into antenna pins 116/118. In addition, the pre-defined criteria can instruct the processor 134 to couple the antenna 112/114 with the highest impedance to its respective LNA 122/124 in order to operate the receiver 110 at a lower power, as will be described in more detail below in connection with FIG. 4.

FIG. 4 is a schematic block diagram illustrating the FM radio receiver 110 including variable gain stages in accordance with the present invention. Each of the gain stages FM receiver 110 (e.g., the LNAs 122/124, Gm 126, mixer 128, LPF 130 and ADC 132) are substantially linear in order to minimize out of band spurious transmissions. In addition, by maintaining a constant voltage, a high Q, high impedance antenna 112/114 (e.g., greater than 2 kΩ with a Q of 30 in the FM frequency band and an inductance of at least 120 nanohenry) may be used. As such, the FM receiver 110 can be operated at a much lower power than when a traditional 50 Ω antenna is used.

To maintain a constant voltage, in one embodiment, the FM radio receiver 110 in FIG. 4 includes a receiver signal strength indicator (RSSI) 138 coupled to the output of the various gain stages (LNAs 122/124, Gm 126, mixer 128, LPF 130 and ADC 132). The RSSI 138 measures the output power at the output of the various gain stages and generates a power control signal (RSSI_Out) 140 indicative of the output power. The power control signal 140 is input to the digital baseband processor 134, which uses the power control signal 140 to generate gain control signal(s) 142, 144, 145, 146 and 148 o control the gains of the ADC 132, LPF 130, Gm 126 and LNAs 122/124, respectively, in order to maintain a constant transmit voltage.

For example, the digital baseband processor 134 can compare the measured output power of each gain stage to a desired output power thereof to determine a power offset therebetween. The digital baseband processor 134 can then calculate the respective gains of the ADC 132, LPF 130, Gm 126 and LNAs 122/124 that are needed in order to minimize the power offset, and therefore, bring the measured output power substantially equal to the desired output power. Once the gains have been calculated, the digital baseband processor can generate and transmit a gain control signal (ADC_CTL) 142 to the ADC 132 to set the gain of the ADC 132, a gain control signal (LPF_CTL) 144 to the LPF 130 to set the gain of the LPF 130, a gain control signal (MIXER_CTL) 145 to set the gain of the mixer 128, a gain control signal (Gm_CTL) 146 to the Gm 126 to set the gain of the Gm 126 and a gain control signal (LNA_CTL) 148 to the LNAs 122/124 to set the gain of the LNAa 122/124.

This process can be repeated recursively until the power offset between the measured and desired output power is sufficiently minimized or eliminated. In an exemplary embodiment, this process is performed during an off-line calibration operation of the FM receiver 110 and/or during a real-time, on-line, change channel operation of the FM receiver 110.

FIGS. 5-7 are schematic block diagrams illustrating more detailed views of an FM radio receiver 200 in accordance with the present invention. For example, as shown in FIG. 5, the FM radio receiver 200 includes LNAs 212 and 214, gain stages (Gm) 216 and 218 and a mixer 220. Each of the LNA's 212 and 214 is coupled via a respective input pad 208 and 210 to a receiver antenna 202 via an optional filter 204 and balun 206. In addition, the FM receiver 200 further includes additional LNA's 230 and 232, coupled via input pad 228 to a transmitter antenna 226. The additional LNAs 230 and 232 may be coupled to the transmitter antenna 226 via a Tx/Rx switch module, as shown in FIG. 2. For example, a Tx/Rx switch module can couple the transmitter antenna 226 to either LNAs 230/232 or to a power amplifier (PA) 234 of the transmitter (Tx). As such, the LNas 230/232 may be positioned within the transmitter and coupled to the receiver 200.

The components shown in FIGS. 5-7 correspond, at least in part, to the functionality of blocks 112-128 of FIG. 3. For example, LNAs 212 and 214 can correspond to LNA 122, while LNAs 230 and 232 can correspond to LNA 124. In addition, gain stages 216 and 218 can correspond to gain stage 126 and mixer 220 can correspond to mixer 128.

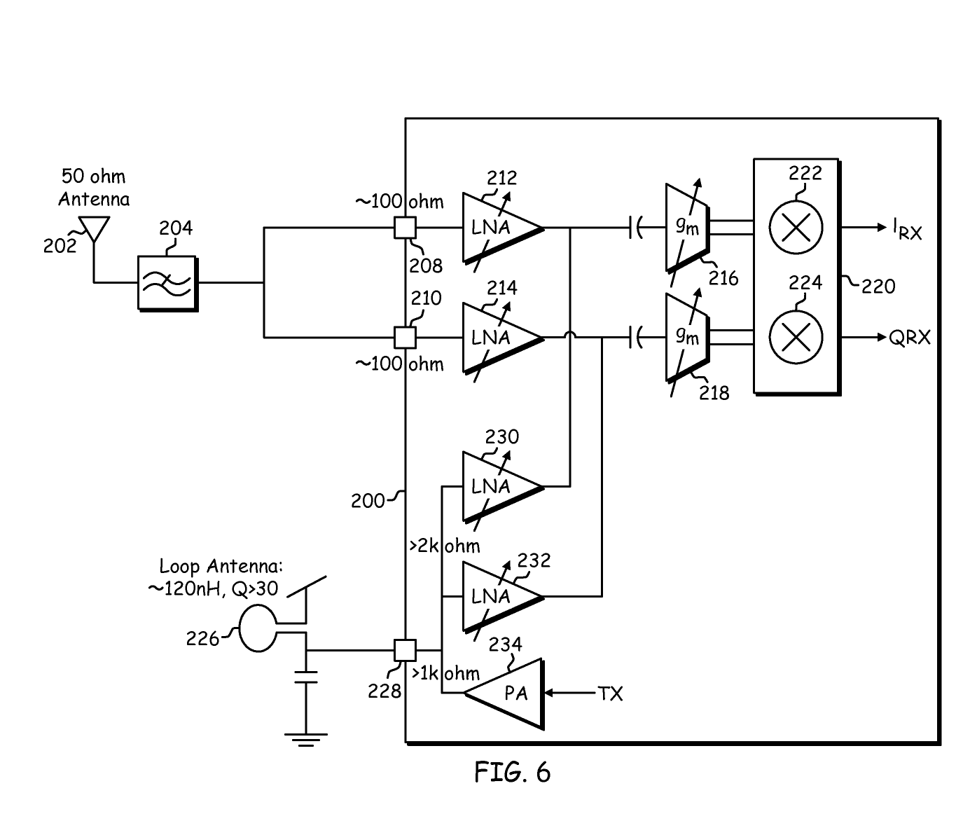

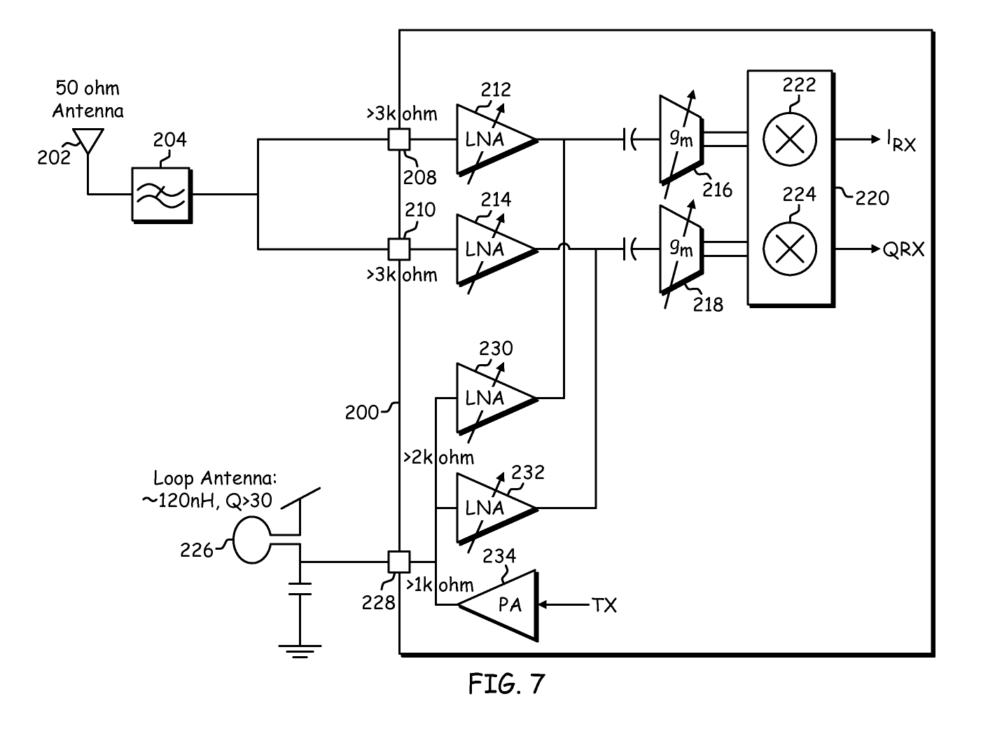

Each of FIGS. 5-7 illustrates the FM receiver 200 operating in a different mode. For example, FIGS. 5 illustrates an FM receiver 200 operating in a differential mode with antenna matching impedance, FIG. 6 illustrates the FM receiver 200 operating in a single ended mode with antenna matching impedance and FIG. 7 illustrates the FM receiver 200 operating in a single ended mode with no antenna matching impedance.

Turning now to FIG. 5, when the FM receiver 200 is operating in differential mode, the radio frequency (RF) signal at the input to the receiver 200 is a complex signal that includes an in-phase component (I) and a quadrature component (Q). To generate the I and Q signals, the balun 206, which is shown in FIG. 5 as including two capacitors C1 and C2 and an inductor I, receives the RF signal from the antenna 202 and produces two out-of-phase inputs (i.e., roughly 180 degree phase shift) that are input to the receiver 200 via input pads 208 and 210. The in-phase component (I) is provided to a first LNA 212 via input pad 208, while the quadrature component (Q) is provided to a second LNA 214 via input pad 210.

Each of the LNAs 212 and 214 is operable to amplify their respective I/Q signals and provide the amplified I/Q signals to respective optional gain stages (Gm 216 and Gm 218). In addition, the mixer 220 includes two mixers 222 and 224, each coupled to receive a respective one of the amplified I/Q signals and operable to down-convert the I/Q signals from a radio frequency (RF) within the FM frequency band to a baseband or intermediate frequency (e.g., 200 kHz). Although not shown, it should be understood that the outputs I_{RX} and Q_{RX} of the mixers 222 and 224 are input to respective I/Q LPFs and I/Q ADC's, as shown in FIG. 3.

In addition, as shown in FIG. 5, the impedance of the LNA inputs 208/210 is matched to the impedance of the receiver antenna 202. As shown in FIG. 5, the receiver antenna 202 is a 50 ohm antenna, and the impedance at each input pad 208 and 210 is 100 ohms, which produces a series impedance of 200 ohms to the antenna 202. The balun 206 operates to convert the 200 ohm impedance of the LNAs 212/214 into a 50 ohm impedance to match the impedance of the antenna 202.

Furthermore, as shown in FIG. 5, the impedance of the LNA input 228 is matched to the impedance of the transmitter antenna 226. As shown in FIG. 5, the transmitter antenna 226 is a loop antenna with an impedance of at least 2 kΩ, a Q of at least 30 and an inductance substantially equal to 120 nH. Therefore, the impedance at the input pad 228 to the LNA is also at least 2 kΩ to match the impedance of the transmitter antenna 226.

Turning now to FIG. 6, when the FM receiver 200 is operating in single ended mode, the radio frequency (RF) signal at the input to the receiver 200 is an RF signal with a single phase. Therefore, the balun shown in FIG. 5 is not needed and the two input pads 208 and 210 to the LNAs 212 and 214 are shorted to provide a single phase to the inputs 208/210.

As in FIG. 5, each of the LNAs 212 and 214 is operable to amplify the RF signal and provide the amplified RF signal to respective optional gain stages (Gm 216 and Gm 218) and respective mixers 222 and 224 to down-convert the amplified RF signal to a near baseband signal. In addition, although not shown, it should be understood that the outputs of the mixers 222 and 224 are input to respective LPFs and ADC's that also operate in single-ended mode (same phase on both branches).

In FIG. 6, the impedance of the LNA inputs 208/210 is also matched to the impedance of the receiver antenna 202. Since the inputs 208/210 are shorted in single ended mode, the two impedances are in parallel, which produces an impedance of 50 ohms to the antenna 202.

Turning now to FIG. 7, the FM receiver 200 is again operating in single ended mode, but the impedance of the LNA inputs 208/210 is not matched to the impedance of the receiver antenna 202. Instead, as shown in FIG. 7, the impedance at each input pad 208 and 210 is at least 3 kΩ, thus producing a high impedance (e.g., at least 1.5 kΩ) to the receiver antenna 202. By providing a high input impedance to the LNAs 212 and 214, receiver performance can be improved because even if the antenna impedance changes with movement or coupling to other sources of impedance (e.g., user hand), the antenna still detects the same potential across the LNAs 212/214.

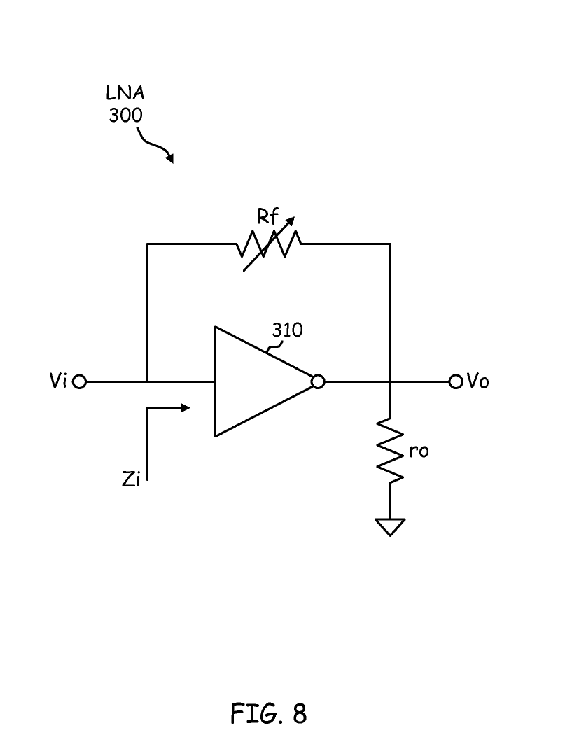

FIG. 8 illustrates an exemplary programmable low noise amplifier 300 for use within the FM radio receiver in accordance with the present invention. The LNA 300 can correspond, for example, to any of the LNAs 122, 124, 212, 214, 230 and 232 shown in previous Figures. The LNA 300 includes an inverter 310 and a variable feedback resistor Rf. In FIG. 8, Vi refers to the input voltage, Vo refers to the output voltage, ro refers to the output impedance and Zi refers to the input impedance. The input impedance Zi of the LNA 300 is set according to the following equation:

$$Zi = \frac{ro + Rf}{1 + gm \cdot ro} , \qquad ( Equation 1 )$$

where gm is the gain of the LNA 300. Thus, as can be seen in Equation 1, the input impedance of the LNA 300 is directly proportional to the resistance of the variable feedback resistor Rf. As such, in order to set the input impedance to the desired value, the processor (shown in FIG. 3) can set the resistance of the variable feedback resistor Rf to a value that will produce the desired input impedance.

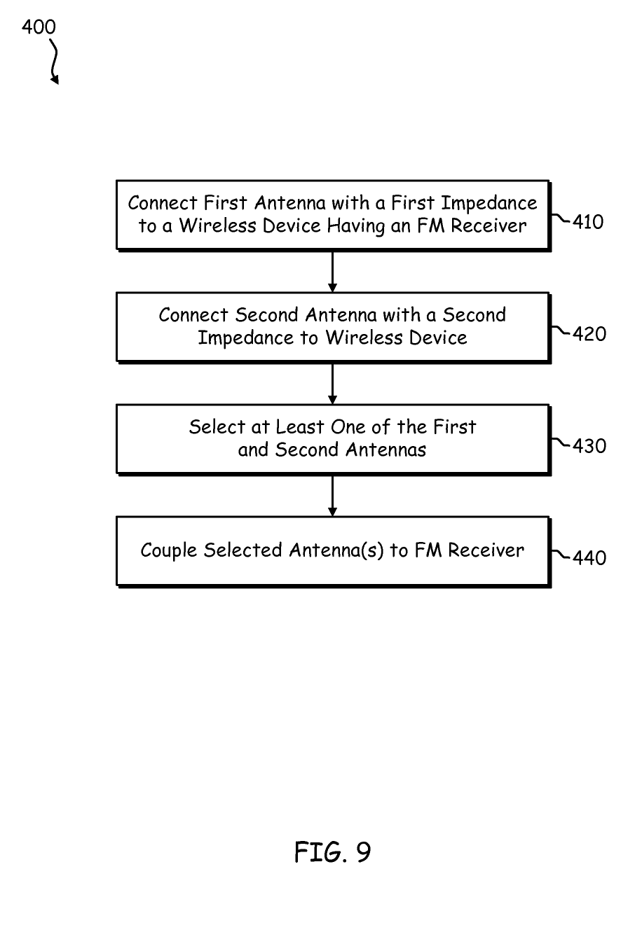

FIG. 9 is a logic diagram of a method 400 for operating a wireless device including an FM radio receiver in accordance with the present invention. The method begins at step 410, where a first antenna having a first impedance is connected to the wireless device. At step 420, a second antenna with a second impedance is connected to the wireless device. The method proceeds at step 430, where at least one of the first and second antennas is selected, and the method concludes at step 440, where the selected antenna(s) are coupled to the FM receiver.

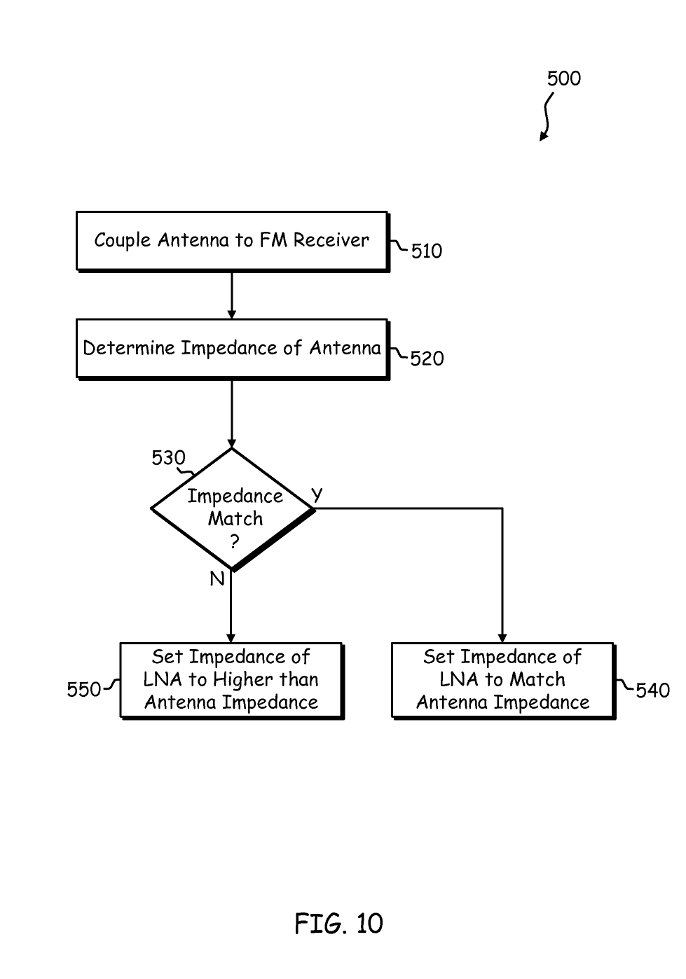

FIG. 10 is a logic diagram of a method 500 for configuring an FM radio receiver, in accordance with the present invention. The method begins at step 510, where an antenna is coupled to the FM receiver. At step 520, the impedance of the antenna is determined, either based on manufacturer specifications or in response to a measured impedance by the FM receiver. At step 530, a decision is made whether antenna impedance matching of the FM receiver is desired. If so, at step 540, the impedance of one or more low noise amplifiers (LNAs) within the FM receiver coupled to the antenna is set to produce a matching impedance to the antenna. If not, at step 550, the impedance of one or more LNAs coupled to the antenna is set to produce an impedance to the antenna that is higher than the antenna impedance.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has further been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The preceding discussion has presented an FM receiver and method of operation thereof. As one of ordinary skill in the art will appreciate, other embodiments may be derived from the teaching of the present invention without deviating from the scope of the claims.

What is claimed is:

1. A wireless device, comprising:
a first antenna pin coupled to a first antenna with a first impedance;
a second antenna pin coupled to a second antenna with a second impedance;
a switch for selecting at least one of the first antenna and the second antenna; and
a receiver coupled to receive an inbound radio frequency (RF) signal from the selected ones of the first antenna and the second antenna.

2. The wireless device of claim 1, wherein the receiver further includes:
a first low noise amplifier coupled to the first antenna pin to receive the inbound RF signal from the first antenna when the first antenna is selected by the switch and operable to amplify an inbound RF signal to produce a first amplified inbound signal.

3. The wireless device of claim 2, further comprising:
a second low noise amplifier coupled to the second antenna pin to receive the inbound RF signal from the second antenna when the second antenna is selected by the switch and operable to amplify the inbound RF signal to produce a second amplified inbound signal.

4. The wireless device of claim 3, further comprising:
a transmitter coupled to the second antenna pin and including the second low noise amplifier.

5. The wireless device of claim 3, wherein the receiver further includes:
a down-conversion module coupled to the first low noise amplifier and the second low noise amplifier and operable to convert at least one of the first amplified inbound signal and the second amplified inbound signal to a near baseband signal;
a low pass filter coupled to the down-conversion module and operable to filter the near baseband signal to produce a filtered baseband signal; and
an analog-to-digital converter coupled to the down-conversion module and operable to convert the filtered baseband signal into a digital baseband signal; and
a processor coupled to the analog-to-digital converter and operable to convert the digital baseband signal into inbound digital symbols.

6. The wireless device of claim 5, wherein:
the inbound RF signal includes an in-phase signal and a quadrature signal;
the first low noise amplifier includes a first in-phase low noise amplifier and a first quadrature low noise amplifier for amplifying the in-phase signal and the quadrature signal, respectively, to produce a first in-phase amplified signal and a first quadrature signal, respectively;
the second low noise amplifier includes a second in-phase low noise amplifier and a second quadrature low noise amplifier for amplifying the in-phase signal and the quadrature signal, respectively, to produce a second in-phase amplified signal and a second quadrature signal, respectively;
the down-conversion module includes first and second down-conversion modules for down-converting at least one of the first and second in-phase amplified signal and the first and second in-phase amplified quadrature signal, respectively, to produce an in-phase baseband signal and a quadrature baseband signal, respectively;
the low pass filter includes first and second low pass filters for filtering the in-phase baseband signal and the quadrature baseband signal, respectively, to produce a filtered in-phase baseband signal and a filtered quadrature baseband signal, respectively; and
the analog-to-digital converter includes first and second analog-to-digital converters for converting the filtered in-phase baseband signal and the filtered quadrature baseband signal, respectively, from analog to digital to produce an in-phase digital signal and a quadrature digital signal, respectively.

7. The wireless device of claim 5, wherein the switch selects only one of the first and second antennas.

8. The wireless device of claim 5, wherein:
the switch selects both of the first and second antennas; and
the down-conversion module is coupled to receive a combined amplified inbound signal, the combined amplified inbound signal including the first amplified inbound signal and the second amplified inbound signal.

9. The wireless device of claim 5, wherein the down-conversion module includes a mixer and a gain stage.

10. The wireless device of claim 9, wherein the receiver is a frequency modulated (FM) receiver operable to receive signals within an FM frequency band, the FM receiver further including:
a receiver signal strength indicator coupled to an output of at least one of the first low noise amplifier, the second low noise amplifier, the gain stage, the low pass filter and the analog-to-digital converter and operable to measure an output power at the output, to generate a power control signal indicative of the output power and to provide the power control signal to the processor;
wherein the processor is further operable to generate a gain control signal based on the power control signal to control a respective gain of at least one of the analog-to-digital converter, low pass filter, gain stage, first low noise amplifier and second low noise amplifier.

11. The wireless device of claim 5, wherein the first low noise amplifier and the second low noise amplifier each include a variable resistor operable to set a respective amplifier impedance thereof.

12. The wireless device of claim 11, wherein:
the variable resistor of the first low noise amplifier is operable to set the respective amplifier impedance of the first low noise amplifier to match the first impedance of the first antenna; and
the variable resistor of the second low noise amplifier is operable to set the respective amplifier impedance of the second low noise amplifier to match the second impedance of the second antenna

13. The wireless device of claim 11, wherein:
the variable resistor of at least one of the first low noise amplifier and the second low noise amplifier is operable to set the respective amplifier impedance thereof to a high impedance; and
the high impedance for the first low noise amplifier is higher than the first impedance of the first antenna and the high impedance of the second low noise amplifier is higher than second impedance of the second antenna.

14. The wireless device of claim 13, wherein the high impedance is at least 3 kΩ.

15. The wireless device of claim 1, wherein one of the first and second antennas has a first impedance of less than or equal to 50 Ω and the other of the first and second antennas has a second impedance of greater than or equal to 2 kΩ.

16. The wireless device of claim 1, wherein the receiver is a frequency modulated (FM) receiver and the inbound RF signal has a frequency within an FM frequency band.

17. A method for operating a receiver within a wireless device, comprising:
connecting a first antenna with a first impedance to the wireless device;
connecting a second antenna with a second impedance to the wireless device;
selecting at least one of the first antenna and the second antenna; and
coupling the selected ones of the first antenna and the second antenna to the receiver to receive an inbound radio frequency (RF) signal.

18. The method of claim 17, wherein the connecting steps further include:
connecting the first antenna to a first low noise amplifier within the receiver; and
connecting the second antenna to a second low noise amplifier within a transmitter, the second low noise amplifier being further coupled to the receiver.

19. The method of claim 18, further comprising:
setting a first amplifier impedance of the first low noise amplifier to match the first impedance of the first antenna; and
setting a second amplifier impedance of the second low noise amplifier to match the second impedance of the second antenna.

20. The method of claim 18, further comprising:
setting a respective amplifier impedance of at least one of the first and second low noise amplifiers to a high impedance, wherein the high impedance for the first low noise amplifier is higher than the first impedance of the first antenna and the high impedance of the second low noise amplifier is higher than second impedance of the second antenna.
